(19) United States
(12) Patent Application Publication
(10) Pub. No.: US 2010/0285197 A1
(43) Pub. Date: Nov. 11, 2010

(54) Sweetener Compositions

(76) Inventors: Leanne Fisher, Reading (GB); Carole Ann Bingley, Reading (GB)

Correspondence Address: CANTOR COLBURN, LLP, 20 Church Street, 22nd Floor, Hartford, CT, 06103, US

(21) Appl. No.: 12/527,467

(22) PCT Filed: Feb. 21, 2008
(86) PCT No.: PCT/GB08/00590

§ 371 Date: Apr. 7, 2010

(30) Foreign Application Priority Data
Feb. 23, 2007 (GB) 0703524.9

(51) Int. Cl. A23L 1/236; A23L 1/22; A23L 1/28

(52) U.S. Cl. 426/548; 426/538; 426/534

(57) ABSTRACT

The invention relates to a sweetener composition comprising; an extract of a fruit from the Cucurbitaceae family; at least one sugar alcohol; and a component selected from at least one salt of a monocarboxylic acid and/or at least one salt of a dicarboxylic acid, at least one of an alkali metal cation and/or an alkaline earth metal cation or combinations thereof. A method of making such a sweetener composition and the use of the composition in beverage of foodstuffs is also provided. Further, the use of, in combination, at least one sugar alcohol and at least one salt of a monocarboxylic acid and/or at least one salt of a dicarboxylic acid, for reducing a bitter taste of an extract of a fruit from the Cucurbitaceae family, within a sweetener composition is also disclosed.

The present invention relates to improved sweetener compositions, and additionally methods of making improved sweetener compositions.

Lo Han Guo (hereinafter called “LHG”), sometimes spelled Lo Han Kuo, is the common name for the Chinese fruit Momordica grosvenorii (Swingle), also called Siraitia grosvenorii, belonging to the Cucurbitaceae family. Siraitia grosvenorii is an herbaceous perennial vine native to southern China and best known for its fruit, the LHG. Botanical synonyms include Momordica grosvenorii and Thladiantha grosvenorii.

The fruit is well known for its sweet taste. The fruit extract is many times sweeter than sugar, and has been used as a natural sweetener in China for nearly a millennium due to its flavor and low level of food energy.

Agric. Biol. Chem., 53 (12). 3347˜3349, 1989 Sweet Cucurbitane Glycosides from Fruits of Siraitia siamensis (chi-zi-Lo-han-guo), a Chinese Folk Medicine by Ryoji KASAI, Rui-Lin Nie, Kenji NASHI, Kazuhiro OHTANI, Jun ZHOU, Guo-Da TAO and Osamu TANAKA describes a laboratory scale process for the isolation of various glycosides from LHG using chromatography on a highly porous polymer, then on silica gel and finally by HPLC (high performance liquid chromatography) on a reverse phase column.

The compounds which provide the sweet taste of LHG comprise a group of triterpene glycosides including mogroside IV, mogroside V, 11-oxo-mogroside V and siamenoside I. The most abundant triterpene glycoside component of LHG is mogroside V. Mogroside V is reported to be 300 times sweeter than sucrose, and occurs in the fruit at concentrations up to 1% wt. Through extraction, a powder containing up to 80% mogrosides can be obtained. The chemical structure of mogroside V is shown below.

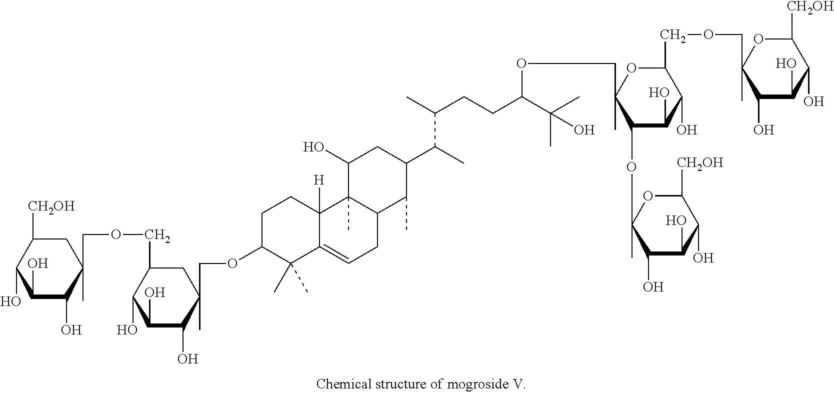

Processing of LHG usually results in several non-sweet off flavors. These aromas limit the use of the extracts as a sweetener to products that additionally have sugar or honey added to them, thereby masking the undesirable off flavors. The use of LHG as a natural high intensity sweetener is therefore limited for inclusion at low levels in soft drinks, and foodstuffs due to the very distinctive flavor. Commercially available LHG is therefore not currently suitable for use as a sole sweetener, and must be used in combination with other sweeteners to achieve the required sweetness intensity.

LHG has been used in beverage formulations as an alternative sweetener to sucrose and artificial high intensity sweeteners but it is not necessarily used exclusively in low calorie drinks. In beverages, there is a move towards using natural sweeteners as an alternative to sucrose and artificial high intensity sweeteners, and therefore LHG is of interest for such a use.

Various sweetener blends incorporating, or optionally incorporating, LHG have been proposed in the prior art. US 2003/0170365 A1 discloses a blend of LHG fruit concentrate powder, isomalt and fructo-oligosaccharide so as to eradicate undesired lingering aftertaste.

US 2004/0058050 A1 discloses a herbal sweetener including LHG, a sugar alcohol and a non-digestible soluble carbohydrate. A combination of LHG, xylitol and maltodextrin is preferred. WO 02/087358 describes the use of one or more non-nutritive sweeteners, a sugar alcohol and D-tagatose in low-calorie products. WO 02/087359 discloses the use of one or more nutritive sweeteners together with sugar alcohol and D-tagatose to lower the calories of a full-calorie beverage or food product while preserving the taste. Neither WO 02/087358 nor WO 02/087359 addresses the issue of off-flavors in LHG.

WO2004/107872 discloses a low carbohydrate sweetener comprising LHG and sucralose liquid having application in the production of low calorie ice cream. The ice cream is free of sugar alcohol.

WO 94/18855 describes a natural sweetening composition using a flavoring system comprising sweet juice derived from the botanical genus/species Siraitia grosvenorii, S. siamensis, S. silomaradjae, S. sikkimensis, S. africana, S. borneensis, S. taiwaniana or mixtures thereof: The composition further comprises sugar and optionally an edible acid and/or edible salt. No sugar alcohol is present.

The present invention seeks to provide a sweetener composition comprising an extract of a fruit from the Cucurbitaceae family, in which unpleasant off-flavors are less perceptible.

In one embodiment there is provided a sweetener composition, said composition comprising;

an extract of a fruit from the Cucurbitaceae family;

at least one sugar alcohol; and

at least one salt of a monocarboxylic acid and/or at least one salt of a dicarboxylic acid.

In an additional embodiment there is provided a method of making a sweetener composition comprising the steps of;

providing an extract of a fruit from the Cucurbitaceae family, and

mixing said extract with at least one sugar alcohol and at least one salt of a monocarboxylic acid and/or at least one salt of a dicarboxylic acid.

A further embodiment provides for the use of, in combination, at least one sugar alcohol and at least one salt of a monocarboxylic acid and/or at least one salt of a dicarboxylic acid, for reducing a bitter taste of an extract of a fruit from the Cucurbitaceae family, within a sweetener composition.

Surprisingly, in the sweetener composition of the present invention, the sugar alcohol and salt of monocarboxylic acid and/or dicarboxylic acid act together to mask the level of off-flavors in the fruit and thus provide a superior taste profile.

Consequently, it has been found that use of a combination of a salt of monocarboxylic acid and/or a dicarboxylic acid together with a sugar alcohol and an extract of a fruit from the Cucurbitaceae family, such as LHG, results in a sweetener composition having significantly reduced bitterness and off-taste properties when compared to known LHG compositions. This reduced bitterness therefore allows for use of the sweetener composition, and therefore the extract of a fruit from the Cucurbitaceae family comprised therein, in higher amounts than before, thereby obtaining the advantages of a natural sweetener with the reduced bitter taste properties.

The sweetener composition of the invention has application in beverages, confectionary, and chewing gum. The sweetener composition of the present invention may be used for full or partial replacement of sugar or artificial sweeteners.

As used herein, the term “an extract of a fruit from the Cucurbitaceae family” refers to extracts obtained from the plant of the family Cucurbitaceae, tribe Jollifieae may be used, for instance sub-tribe Thladianthinae, such as genus Siraitia. The extract of a fruit from the Cucurbitaceae family may be from the genus/species S. grosvenorii, S. siamensis, S. silomaradjae, S. sikkimensis, S. africana, S. borneensis, and S. taiwaniana. The fruit of the genus/species S. grosvenorii, is often called Lo Han Guo fruit.

Although the following description of the products of this invention is described with particular reference to making an LHG extract, other extracts of the Cucurbitaceae family which contain at least 0.01% sweet triterpene glycosides or mogrosides are useful in this invention. In some embodiments, the extracts will contain more than 0.1% to about 15% mogrosides. In some embodiments the extract will be selected from mogroside V, mogroside IV, 11-oxo-mogroside V, siamenoside 1 and mixtures thereof.

The extracts of the fruit from the Cucurbitaceae family may be used in the form of sweet juices, purees, solutions, pastes, or serums. The extract may alternatively be in the form of a solid, such powders, granules, flakes, pellets, or any combination thereof. The solid form of the extract may be solvated with a suitable solvent such as water. The extracts may be in a diluted or concentrated form. The extracts may be used as a single strength juice or powder.

Alternatively, the extract of a fruit from the Cucurbitaceae family may be in the form of a composition which comprises an amount of extract from the fruit in combination with other suitable ingredients or excipients. The composition may also be in the form of a solution that is formed from addition of a sweet juice, puree, solution, paste, serums, or solid such powders, granules, flakes, or pellets, of an extract of a fruit from the Cucurbitaceae family with a suitable solvent, such as water, for example.

In some embodiments the extract of a fruit from the Cucurbitaceae family is in the form of a composition, said composition comprising a powder fruit extract which is solvated in a suitable solvent.

The sugar alcohols used in the present invention may comprise any suitable sugar alcohols. It will be understood that this would include any suitable sugar alcohols capable of being used in the sweetener composition, and thereby facilitating reduction of the bitter taste of the sweetener composition.

Sugar alcohols are also known in the art as polyols, polyhydric alcohols, or polyalcohols. Sugar alcohols are a hydrogenated or partially hydrogenated form of carbohydrate in which the carbonyl group (aldehyde or ketone) is reduced to a primary or secondary hydroxyl group. Sugar alcohols may be used as replacements of sucrose in foodstuffs, and may be combined with high intensity artificial sweeteners (such as aspartame for example) to counter the low sweetness.

Suitable sugar alcohols may include those derived from disaccharides or monosaccharides.

Suitable sugar alcohols, by way of example, may include erythritol, isomalt, lactitol, maltitol, mannitol, sorbitol, xylitol, or any combination thereof.

In some embodiments the sugar alcohols include erythritol, maltitol, and sorbitol.

Specific examples of suitable alcohol sugars include, by way of example, C* Eridex (available commercially from Cargill of Mechelen, Belgium), Neosorb P60, Maltisorb P90, Xylisorb 90, Mannitol 60 (all available commercially from Roquette of Lestrem, France), Isomalt PF (available commercially from Palatinit of Germany), and Lactitol (available commercially from Danisco of Copenhagen, Denmark).

The sugar alcohols may be present in the range 0.1 wt. % to 10 wt. % of the sweetener composition, or in the range 0.5 wt. % to 5.0 wt. %. The sugar alcohols may, in some embodiments, be present in the range 1.0 wt. % to 3.0 wt. %.

The sugar alcohols may be used alone or in any suitable combination. Erythritol and maltitol may be used in combination.

The edible organic salts of monosaccaharide and disaccharide acids used in the present invention may comprise any such salts capable of being used in the sweetener composition of the invention, and thereby facilitating reduction of the bitter taste of LHG. Suitable salts include, by way of example, salts of alkali metal and alkaline earth metal cations, such as calcium, sodium, magnesium, zinc, and potassium salts.

The organic acid salts may be salts of monocarboxylic organic acids. Salts of monocarboxylic acids having a carbon chain length from C1-C10 may be used. Salts of monocarboxylic acids having a linear, optionally branched, backbone having a carbon chain length from C1-C10, and ideally from C1-C6, are used in some embodiments.

In some examples the organic acid salt may include at least one of a gluconate and/or a lactate.

Suitable salts include, by way of example, calcium lactate, magnesium lactate, sodium lactate, calcium gluconate, magnesium gluconate, and sodium gluconate. Magnesium gluconate is used in an embodiment of the invention.

Specific examples of suitable organic salts for use in the invention include, by way of example, Gluconal KG, Puramex MG, Purasal-P, Purasal Hi-Pure P, and Purasal (all available commercially from Purac of Gorinchem, The Netherlands).

The salts of monocarboxylic acid and dicarboxylic acid may be present in the range from 0.001 wt. % to 1.0 wt. % of the sweetener composition. These salts may be present in the range from 0.005 wt. % to 0.1 wt. % or in the range from 0.01 wt. % to 0.05 wt. %.

The salts of monocarboxylic acids and/or dicarboxylic acids may be used alone or in any suitable combination.

The salts of monocarboxylic acid and/or dicarboxylic acid and sugar alcohols may be used in the sweetener composition in any suitable combination. Suitable combinations include, by way of example, erythritol with sodium gluconate, erythritol with magnesium gluconate, erythritol with sodium lactate, malitol with magnesium gluconate, and malitol with sodium gluconate.

In an embodiment of the invention the combination of salt and sugar alcohol includes erythritol with magnesium gluconate.

The sweetener composition may also additionally comprise at least one saccharide. It will be understood that this would include any suitable saccharide capable of being used in the sweetener composition in combination with organic salt and sugar alcohol, and thereby facilitating reduction or masking of the bitter taste of the sweetener composition arising from the extract of a fruit from the Cucurbitaceae family, and in particular an extract from LHG.

Saccharides, or sugars, are known in the art for providing sweet taste sensations for a consumer, thereby providing the sensation of sweetness to a foodstuff or composition to which they are added. Saccharides are based upon relatively simple carbohydrates comprising one or more monosaccharide units.

Suitable saccharides for the present invention include, by way of example, those selected from the groups comprising monosaccharides, disaccharides, and polysaccharides.

Suitable monosaccharides may be selected from the following groups:
Trioses—for example glyceraldehydes, or dihydroxyacetone
Tetroses—for example erythrose, threose, or erythrulose
Pentoses—for example arabinose, lyxose, ribose, xylose, ribulose, or xylulose
Hexoses—for example allose, altrose, galactose, glucose, glucose, idose, mannose, talose, fructose, psicose, sorbose, or tagatose
Heptoses—for example mannoheptulose, or sedoheptulose
Octoses—for example octolose, or 2-keto-3-deoxy-manno-octonate,
Nonoses—for example sialose.

Suitable disaccharides may be selected from sucrose, lactose, maltose, trehalose, or cellobiose, for example.

Suitable polysaccharides include starch and glycogen.

The saccharides may be those selected from monosaccharides, the monosaccharides may be those selected from the hexoses group, such as fructose and/or tagatose.

The saccharides may be present in the range 0.01 wt. % to 10.0 wt. % of the sweetener composition. In some embodiments, the saccharides are present in the range 0.1 wt. % to 5.0 wt. %, or in the range 0.2 wt. % to 1.0 wt. %.

The saccharides may be used alone or in any suitable combination.

The saccharides, sugar alcohols and salts of monocarboxylic acid and dicarboxylic acids may be used in the sweetener composition in any suitable combination. Suitable combinations include, by way of example;

erythritol with tagatose and magnesium gluconate;

erythritol with tagatose and magnesium lactate;

malitol with tagatose and magnesium lactate; and

malitol with tagatose and calcium gluconate.

The combination of salt, sugar alcohol, and saccharide may be erythritol with tagatose and magnesium gluconate.

The edible sweetener composition of the present invention, especially when concentrated or dried, can be used as a sweetener for many purposes. Examples of such uses as a sweetener include addition to edible products such as;
beverages, such as tea, coffee, sodas, carbonated beverages, non-carbonated beverages, fruit juice and fruit-flavored beverages;
foods, such as jams and jellies, peanut butter, pies, puddings, cereals, candies, confectionary, ice creams, yogurts, and popsicles;
health care products, such as dentifrices, mouthwashes, cough drops, cough syrups;
chewing gum, including dental chewing gum and bubble-gum;
use generally as a sugar substitute.

Sweetener compositions of the present invention allow development of a reduced calorie beverage that is sweetened without the inclusion of synthetic high intensity sweeteners.

In an embodiment of the invention there is provided the use of the sweetener composition of the present invention as a sweetener in beverages or foodstuffs (including chewing gum).

It has further been found that the level of off-flavors in the fruit may be masked so as to provide a superior taste profile by a combination of sugar alcohol and alkali metal and/or alkaline earth metal cations.

In a further embodiment, there is provided a sweetener composition, said composition comprising;

an extract of a fruit from the Cucurbitaceae family;

at least one sugar alcohol; and

at least one of an alkali metal cation and/or an alkaline earth metal cation.

According to an additional embodiment there is provided a method of making a sweetener composition comprising the steps of;

providing an extract of a fruit from the Cucurbitaceae family, and

mixing said extract with at least one of an alkali metal cation and/or an alkaline earth metal cation.

In an embodiment of the invention, there is provided the use of, in combination, at least one sugar alcohol and at least one at least one of an alkali metal cation and/or an alkaline earth metal cation for reducing a bitter taste of an extract of a fruit from the Cucurbitaceae family, within a sweetener composition.

The cation of alkaline metal and alkaline earth metal would be provided a salt of an organic or inorganic acid. The anionic component is less important, although salts of monocarboxylic acids and dicarboxylic acids may be used.

Useful cations include cations of magnesium or calcium.

Surprisingly, in the sweetener composition of the present invention, the sugar alcohol and cation of alkali metal and/or alkaline metal act together to mask the level of off-flavors in the fruit and thus provide a superior taste profile.

The sweetener composition of the present invention is added to the edible product in an amount sufficient to provide a sweetening sensation.

The edible product may comprise sweetener composition of the present invention in an amount from 0.001 to 10.0 wt. %, in one embodiment the sweetener may be present in an amount from 0.5 to 5.0 wt. % or in an amount from 1.0 to 4.0 wt. %.

It is envisaged that the sweetener composition of the present invention may be used in the form of a sweet juice, puree, paste, solution, serum, or solid, such powders, granules, flakes, or pellets, which may be in a diluted or concentrated form.

The sweetener composition in the form of a sweet juice, puree, solution, paste, or serum may be dry treated to produce a solid form, such as a powder, granule, flake, or pellet, which is used in a foodstuff or beverage.

The edible product may be coated with the sweetener composition of the present invention for use in, for example, batters, frozen foods, sauces, fillings, and other nutritive ingredients. Examples of frozen foods include sauces, desserts, pastries and the like.

For the batters of cakes, cookies, breads, pastries and pie doughs the sweetener composition of the present invention may typically be included with water. The amounts of components and ingredients used in the batter composition are those amounts and ingredients typically used in preparing baked foods. The compositions can be prepared according to any methods.

The sweetener composition of the present invention may be combined with additional ingredients such as flavoring systems.

The flavoring system may comprise flavors selected from fruit flavors, botanical flavors and mixtures thereof. Possible fruit flavors include the citrus flavors such as orange flavors, lemon flavors, lime flavors and grapefruit flavors. Besides citrus flavors, a variety of other fruit flavors can be used such as apple flavors, grape flavors, cherry flavors, pineapple flavors and the like. These fruit flavors can be derived from natural sources such as fruit juices and flavor oils, or else be synthetically prepared.

The flavor component can comprise a blend of various flavors e.g. lemon and lime flavors, citrus flavors and selected spices (the typical cola soft drink flavor) etc. If desired, fruit juices such as orange juice, lemon juice, lime juice, apple juice, grape juice and the like can be used in the flavor component. The flavor in the flavor component is sometimes formed into emulsion droplets which are then dispersed in the beverage drink. Because these droplets usually have a specific gravity less than that of water and would therefore form a separate phase, weighting agents (which can also act as clouding agents) are typically used to keep the emulsion droplets dispersed in the beverage. Examples of such weighting agents are brominated vegetable oils (BVO) and resin esters, and in particular ester gums.

The flavoring system may also comprise milk or milk type flavors.

The sweetener composition of the present invention may be blended with other juices and flavors to make low calorie beverages. Such other juices include apple, cranberry, pear, peach, plum, apricot, nectarine, grape, cherry, currant, raspberry, gooseberry, blackberry, blueberry, strawberry, lemon, orange, grapefruit, potato, tomato, lettuce, celery, spinach, cabbage, watercress, dandelion, rhubarb, carrot, beet, cucumber, pineapple, custard-apple, pomegranate, guanabana, kiwi, mango, papaya, banana, watermelon, passion fruit and cantaloupe. In some embodiments the other juices are apple, pear, lemon, grapefruit, cranberry, orange, strawberry, grape, kiwi, pineapple, passion fruit, mango, guava, cherry, rosehips, lychee, water chestnuts and cane sugars. Citrus juices may be for blended with the sweetener composition of the present invention because of the high acidity of the citrus juice.

In addition to the flavoring systems and the sweetener composition of the present invention, the beverage or foodstuff (including chewing gum) may also comprise a mineral supplementation or a vitamin supplementation or mixtures thereof. The mineral supplementation may comprise calcium, potassium, magnesium, iron, sodium, or mixtures of these minerals. Also trace mineral supplementation can be incorporated into the beverages. Amounts and methods for incorporation of the mentioned minerals are well known in the art. The level of the minerals is selected so as not to deteriorate the taste characteristics of the beverage composition.

Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

Supplemented ascorbic acid (i.e. vitamin C) may be added to the beverage in an amount of up to 0.15%. Supplemented ascorbic acid is that which is added to the beverage and does not include that which may be incorporated by the flavoring system and the sweetener composition. The ascorbic acid should be easily solubilized in the beverage. It can be synthetic or natural, for example extracted from fruits or vegetables.

Other optional ingredients can be included in the beverages. For example, preservatives, vitamins, pharmaceuticals, such as caffeine and antioxidants (polyphenols, for example), and other minerals can be included. Suitable vitamins include A, D, E, B1, B2, B6, B12, K, niacin, panthotenic acid, folic acid, biotin, and beta carotene. Other minerals which can be included are calcium, zinc, manganese, copper, and other trace minerals. If desired, natural and synthetic colorings can be included in these beverages.

### Use of the Invention in Chewing Gum

As discussed previously, the invention has application in chewing gum technology.

The sweetener composition of the invention may be used as a bulk sweetener in chewing gum. For coated gums, the sweetener composition of the invention may additionally, or alternatively, be used in the coating. The sweetener composition of the invention may be used as the sole sweetener or alternatively in combination with one or more other sweeteners.

The elastomers (rubbers) employed in the gum base of the chewing gum will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof. Specific examples of elastomers include polyisobutylene, styrene butadiene rubber, butyl rubber, and combinations thereof.

In addition to the components set out above, the gum base may include a variety of other ingredients, such as components selected from elastomer solvents, emulsifiers, plasticizers, fillers, and mixtures thereof. As mentioned above, the use of elastomer solvents is not needed to masticate the rubber during the manufacturing process. It may be present in limited amounts, but can lessen from the non-stick properties of the gum base if used in amounts above about 5% by weight of the gum base. In certain embodiments of the invention, elastomer solvents may be used in amounts of about 4% to about 5% by weight of the gum base to provide non-stick properties which are sufficient to provide non-stick properties to teeth, dentures, oral implants and other oral prosthetics.

In some embodiments, the gum base may include bulking agents that are water-insoluble and/or mineral-based. In particular, the gum base also may include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, starch, tricalcium phosphate, dicalcium phosphate, calcium sulfate, atomite, and the like, and mixtures thereof. These fillers or adjuvants may be used in the gum base compositions in various amounts. The filler may be present in an amount from about zero to about 60% by weight of the gum base and/or composition and, more specifically, from about zero to about 50% by weight and, even more specifically, from about zero to about 40%, by weight, of the gum base and/or chewing gum composition. In some embodiments, the filler may be present in an amount from about 0% by weight to about 30% by weight of the gum base and/or chewing gum composition. Moreover, in some embodiments, the amount of filler will be from about zero to about 15% by weight of the gum base and/or chewing gum composition and, more specifically, from about 3% to about 11%, by weight, of the gum base and/or chewing gum composition. In other embodiments, the amount of filler, when used, may be present in an amount from about 15% to about 40% and, desirably, from about 20% to about 30% by weight of the gum base.

The chewing gum compositions may include one or more bulk sweeteners in addition to the sweetener composition of the present invention, such as sugars, sugarless bulk sweeteners, or the like, or mixtures thereof. In some embodiments the total amount of bulk sweeteners is in the range from about 5% to about 99% by weight of the chewing gum composition.

The chewing gum compositions also may include flavors (i.e., flavorings or flavor agents). Flavors which may be used include those flavors known to the skilled artisan, such as natural and artificial flavors. These flavors may be chosen from synthetic flavor oils and flavoring aromatics and/or oils, oleoresins and extracts derived from plants, leaves, flowers, fruits, and so forth, and combinations thereof.

A variety of other traditional ingredients also may be included in the chewing gum products in effective amounts such as coloring agents, antioxidants, preservatives, and the like. Coloring agents may be used in amounts effective to produce the desired color. The coloring agents may include pigments which may be incorporated in amounts up to about 6%, by weight of the composition. For example, titanium dioxide may be incorporated in amounts up to about 2%, and may be present in less than about 1%, by weight of the composition. The colorants may also include natural food colors and dyes suitable for food, drug and cosmetic applications. These colorants are known as F.D.& C. dyes and lakes. The materials acceptable for the foregoing uses may be water-soluble. Illustrative non-limiting examples include the indigoid dye known as F.D.& C. Blue No.2, which is the disodium salt of 5,5-indigotindisulfonic acid. Similarly, the dye known as F.D.& C. Green No.1 comprises a triphenylmethane dye and is the monosodium salt of 4-[4-(N-ethyl-p-sulfoniumbenzylamino)diphenylmethylene]-[1-(N-ethyl -N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference.

Additional additives, such as sensates including physiological cooling agents; warming agents and tingling agents; throat-soothing agents; spices; herbs and herbal extracts, tooth-whitening agents; breath-freshening agents; vitamins and minerals; bioactive agents; caffeine; nicotine; drugs and other actives may also be included in any or all portions or regions of the chewing gum products. Such components may be used in amounts sufficient to achieve their intended effects.

Suitable cooling agents are further described in the following U.S. patents, all of which are incorporated in their entirety by reference hereto: U.S. Pat. Nos. 4,230,688 and 4,032,661 to Rowsell et al.; U.S. Pat. No. 4,459,425 to Amano et al.; U.S. Pat. No. 4,136,163 to Watson et al.; U.S. Pat. No. 5,266,592 to Grub et al.; and U.S. Pat. No. 6,627,233 to Wolf et al. Cooling agents are generally present in amount of 0.01% to about 10.0%.

Warming agents may be selected from a wide variety of compounds known to provide the sensory signal of warming to the individual user. These compounds offer the perceived sensation of warmth, particularly in the oral cavity, and often enhance the perception of flavors, sweeteners and other organoleptic components. Useful warming agents include those having at least one allyl vinyl component, which may bind to oral receptors.

Tingling agents may provide a tingling, stinging or numbing sensation to the user. In some embodiments, a sensation is created due to effervescence. Such effervescence is created by combining an alkaline material with an acidic material, either or both of which may be encapsulated. Examples of “tingling” type sensates can be found in U.S. Pat. No. 6,780,443, the entire contents of which are incorporated herein by reference for all purposes. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,424 to Nakatsu et al., each of which is incorporated by reference herein in its entirety.

A variety of oral care products also may be included in some embodiments of the instant chewing gum compositions. Such oral care products may include tooth whiteners, stain removers, anti-calculus agents, and anti-plaque agents. Oral care agents that may be used include those actives known to the skilled artisan, such as, but not limited to, surfactants, breath-freshening agents, anti-microbial agents, antibacterial agents, oral malodor control agents, fluoride compounds, quaternary ammonium compounds, remineralization agents and combinations thereof. Examples are included in the following U.S. patents which are incorporated in their entirety herein by reference: U.S. Pat. No. 5,227,154 to Reynolds, U.S. Pat. No. 5,378,131 to Greenberg and U.S. Pat. No. 6,685,916 to Holme et al. Suitable oral care actives such as remineralization agents, antimicrobials, and tooth-whitening agents are described in assignee's co-pending U.S. patent application Ser. No. 10/901,511, filed Jul. 29, 2004 and entitled “Tooth-Whitening Compositions and Delivery Systems Therefor,” which is incorporated herein by reference in its entirely, and the like, and mixtures thereof.

A variety of drugs, including medications, herbs, and nutritional supplements may also be included in the chewing gum compositions.

Examples of active ingredients contemplated for use in the chewing gum compositions include antacids, H2-antagonists, and analgesics. For example, antacid dosages can be prepared using the ingredients calcium carbonate alone or in combination with magnesium hydroxide, and/or aluminum hydroxide. Moreover, antacids can be used in combination with H2-antagonists.

Various herbs also may be included such as those with various medicinal or dietary supplement properties. Herbs are generally aromatic plants or plant parts that can be used medicinally or for flavoring.

Acidulants also may be included in the chewing gum compositions. Suitable acidulants include, for example, malic acid, adipic acid, citric acid, tartaric acid, fumaric acid, and mixtures thereof.

Any of the aforementioned additives for use in a chewing gum composition, as well as other conventional additives known to one having ordinary skill in the art, such as thickeners, may be incorporated into the chewing gum base of the chewing gum compositions or any coating that the chewing gum product may contain.

The chewing gum compositions may be formed into a variety of shapes and sizes and may take various product forms, including without limitation, sticks, slabs, chunks, balls, pillows, tablet, pellet, center-filled, pressed tablet, deposited, compressed chewing gum or any other suitable format, as well as coated and uncoated forms.

When the chewing gum compositions are formed into coated products, the coating may be applied by any method known in the art. The coating composition may be present in an amount from about 2% to about 60%, or from about 25% to about 35% by weight of the total center-filled gum piece, in some embodiments from about 25% to about 45% by weight of the total chewing gum piece, or in an amount about 30% by weight of the gum piece.

Such coated chewing gums are typically referred to as pellet gums. The outer coating may be hard or crunchy. Any suitable coating materials known to those skilled in the art may be employed. Typically, the outer coating may include the sweetener composition of the present invention, optionally in combination with any of sorbitol, maltitol, xylitol, isomalt, erythritol, isomalt, and other crystallizable polyols; sucrose may also be used. Furthermore, the coating may include several opaque layers, such that the chewing gum composition is not visible through the coating itself, which can optionally be covered with a further one or more transparent layers for aesthetic, textural and protective purposes. The outer coating may also contain small amounts of water and gum arabic. The coating can be further coated with wax. The coating may be applied in a conventional manner by successive applications of a coating solution, with drying in between each coat. As the coating dries it usually becomes opaque and is usually white, though other colorants may be added. A polyol coating can be further coated with wax. The coating can further include colored flakes or speckles. If the composition includes a coating, it is possible that one or more oral care actives can be dispersed throughout the coating. This may be useful if one or more oral care actives is incompatible in a single phase composition with another of the actives. Flavors may also be added to yield unique product characteristics.

Other materials may be added to the coating to achieve desired properties. These materials may include, without limitations, cellulosics such as carboxymethyl cellulose, gelatin, xanthan gum, and gum arabic.

For instance, center-fill chewing gum embodiments may include a center-fill region, which may be a liquid or powder or other solid, and a gum region. Some embodiments also may include an outer gum coating or shell, which typically provides a crunchiness to the piece when initially chewed. The outer coating or shell may at least partially surround the gum region.

Some other chewing gum embodiments may be in a compressed gum format, such as, for example, a pressed tablet gum. Such embodiments may include a particulate chewing gum base, which may include a compressible gum base composition and a tableting powder.

Use of the Invention in Combination with a Taste Potentiator

The sweetener compositions of the invention may be used in combination with a taste potentiator, for example in beverages. Such compositions would include the sweetener composition of the invention, as at least one active ingredient substance, and optionally one or more other ingredients and a taste potentiator which may increase the perception of the active substance.

In some embodiments, the active substance(s) included in the potentiator compositions may be present in amounts of about 1% to about 95% by weight of the composition, or about 5% to about 30% by weight of the composition.

Any of a variety of substances that function as taste potentiators may be employed in the compositions described herein. The active substance(s) may comprise any component for which the perception is enhanced in some manner by the presence of one or more taste potentiators. Suitable active substances include, but are not limited to, compounds that provide flavor, sweetness, tartness, umami, kokumi, savory, saltiness, cooling, warmth or tingling. Other suitable actives include oral care agents, nutraceutical actives and pharmaceutical actives. Combinations of active substances also may be employed.

Compounds that provide flavor (flavorings or flavor agents), which may be used include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

Generally any flavoring or food additive such as those described in Chemicals Used in Food Processing, publication 1274, pages 63-258, by the National Academy of Sciences, may be used. This publication is incorporated herein by reference.

In some embodiments, the flavor agent may be employed in either liquid form and/or dried form. When employed in the latter form, suitable drying means such as spray drying the oil may be used. Alternatively, the flavor agent may be absorbed onto water soluble materials, such as cellulose, starch, sugar, maltodextrin, gum arabic and so forth or may be encapsulated. The actual techniques for preparing such dried forms are well-known.

In some embodiments, the flavor agents may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

Compounds that provide sweetness (sweeteners or sweetening agents) may be included in addition to the sweetener compositions of the invention. These may include additional bulk sweeteners such as sugars, sugarless bulk sweeteners, or the like, or mixtures thereof.

Intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

Compounds that provide a cooling sensation may include physiological cooling agents. A variety of well known cooling agents may be employed. Suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

Compounds that provide warmth (warming agents) may be selected from a wide variety of compounds known to provide the sensory signal of warming to the individual user. These compounds offer the perceived sensation of warmth, particularly in the oral cavity, and often enhance the perception of flavors, sweeteners and other organoleptic components. Useful warming agents include those having at least one allyl vinyl component, which may bind to oral receptors. Compounds that provide a tingling sensation also are known and referred to as “tingling agents.” Tingling agents may be employed to provide a tingling, stinging or numbing sensation to the user. In some embodiments, a sensation is created due to effervescence. Such effervescence is created by combining an alkaline material with an acidic material, either or both of which may be encapsulated. Examples of “tingling” type sensates can be found in U.S. Pat. No. 6,780,443, the entire contents of which are incorporated herein by reference for all purposes. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,424 to Nakatsu et al., each of which is incorporated by reference herein in its entirety.

Oral care agents that may be used include those actives known to the skilled artisan, such as, but not limited to, surfactants, breath freshening agents, anti-microbial agents, antibacterial agents, anti-calculus agents, anti-plaque agents, oral malodor control agents, fluoride compounds, quaternary ammonium compounds, remineralization agents and combinations thereof.

Other oral care actives known to those skilled in the art are considered well within the scope of the present invention.

Pharmaceutical actives include drugs or medicaments, breath fresheners, vitamins and other dietary supplements, minerals, caffeine, nicotine, fruit juices, and the like, and mixtures thereof.

### Beverage Compositions

In some embodiments, the potentiator compositions may reside in a beverage composition including at least one active substance including the sweetener composition of the invention and at least one taste potentiator. Beverages suitable for use herein include, for example, soft or carbonated drinks, juice-based drinks, milk-based drinks, beverages made from brewed components such as teas and coffees, beverage mixes, beverage concentrates, powdered beverages, beverage syrups, frozen beverages, gel beverages, alcoholic beverages, and the like.

### Juice-Based Compositions

Juice-based compositions generally contain a juice component obtained from fruit or vegetable. The juice component can be used in any form such as a juice form, a concentrate, an extract, a powder, or the like.

Suitable juices include, for example, citrus juice, non-citrus juice, or mixtures thereof, which are known for use in beverages.

Unless otherwise indicated, juice as used can include fruit or vegetable liquids containing a percentage of solids derived from the fruit or vegetable, for example pulp, seeds, skins, fibers, and the like, and pectin, which is naturally occurring in the fruit or vegetable. The amount of solids in the juice can be about 1 to about 75 wt %, or about 5 to about 60 wt %, or about 10 to about 45 wt %, or about 15 to about 30 wt % each based on the total weight of the juice. Higher concentrations of solids can be found in juice concentrates, purees, and the like.

The amount of juice component present in the juice-based composition generally can be about 0.1 wt % to about 95 wt % based on the total weight of the composition, or about 5 wt % to about 75 wt %, or about 10 wt % to about 50 wt % each based on the total weight of the composition. Amounts may vary depending upon whether the composition is a concentrate or a ready to drink beverage, for example. The remaining components in the juice-based composition can be added water or other suitable liquid, a sweetening agent, a flavoring agent, or other additives as described herein.

The juice-based composition can be non-carbonated or carbonated.

### Milk-Based Compositions

Milk-based compositions generally contain a dairy component which can contain varying amounts of milk proteins (e.g., casein, whey protein, and the like), fats, lactose, and water. Exemplary dairy components include yogurt, cream, whole milk, low or reduced fat milk, skim milk, milk solids, condensed milk, or a combination comprising at least one of the foregoing dairy components.

In some embodiments, non-dairy components may replace part or all of the dairy components in the milk-based composition. Suitable non-dairy components include soy milk, almond milk, coconut milk, rice milk, and the like, or a combination comprising at least one of the foregoing.

### Alcoholic Compositions

The compositions described herein may further comprise an alcoholic composition. Examples of suitable alcoholic compositions include beer, spirit, liqueur, wine, or a combination comprising at least one of the foregoing. In some embodiments, the level of alcohol, as measured by the amount of ethanol contained in the beverage composition can be about 0.5 vol % to about 20 vol % based on the total volume of the beverage composition.

### Carbonated Compositions

A carbonated beverage composition typically contains about 0.1 to about 5.0 volumes of gas or gasses, typically carbon dioxide, per volume of the beverage composition. The carbonation can be effected by forceful introduction of the gas under pressure to the beverage composition. Cooling the beverage composition allows for greater amounts of carbon dioxide to be solubilized by the beverage composition. Carbonation can be used to enhancing the flavor, sweetness, taste, and mouth-feel of the composition. Additionally, carbonation lowers the pH of the composition.

In one embodiment, the carbonation can be added to the finished, noncarbonated beverage composition, which contains all of the desired beverage components.

In another embodiment, the carbonation is added to a desired volume of water to form a carbonated water. The carbonated water can then be combined with a composition such as a beverage concentrate or beverage syrup to produce the finished carbonated beverage composition.

### Frozen Compositions

A “frozen beverage composition” as used herein includes a beverage composition having ice crystals suspended therein to provide a viscous, yet drinkable beverage. The consistency of the frozen beverage composition allows it to have a “slushy” or “spoonable” consistency. The ice crystals can be present in the frozen beverage composition in an amount of about 20 to about 90 wt %, or about 30 to about 70 wt %, or about 40 to about 50 wt % ice solids each based on the total weight of the frozen beverage composition.

Due to the lower temperature of the frozen beverage composition compared with other beverages, choice in the amount of flavoring agent and/or sweetening agent can be different. Suitable amounts of flavoring agent and sweetening agent can be selected by one of ordinary skill in the art without undue experimentation.

### Gel Compositions

A “gel beverage composition” as used herein includes a beverage composition having a thickening agent to provide a viscous, yet drinkable beverage. The consistency of the gel beverage composition allows it to have a “semi-solid” or “spoonable” consistency. Thickening agents (sometimes referred to as hydrocolloids) can include, but are not limited to natural and synthetic gums, for example locust bean gum, guar gum, gellan gum, xanthan gum, gum ghatti, modified gum ghatti, tragacanth gum, carrageenan, and the like; natural and modified starches, for example pregelatinized starch (corn, wheat, tapioca), pregelatinized high amylose-content starch, pregelatinized hydrolyzed starches (maltodextrins, corn syrup solids), chemically modified starches such as pregelatinized substituted starches (e.g., octenyl succinate), and the like; cellulose derivatives, for example carboxymethylcellulose, sodium carboxymethylcellulose, and the like; polydextrose; whey or whey protein concentrate; pectin; gelatin; or a combination comprising at least one of the foregoing thickening agents.

Due to the textural difference of the gel beverage composition compared with other beverages, choice in the amount of flavoring agent and/or sweetening agent can be different. Suitable amounts of flavoring agent and sweetening agent can be selected by one of ordinary skill in the art without undue experimentation.

Any of the beverage compositions described herein may include flavors and optional sweeteners in addition to the sweetener composition of the invention and a variety of optional additives. In some embodiments, the composition may include optional additives such as antioxidants, amino acids, caffeine, coloring agents (“colorants”, “colorings”), emulsifiers, flavor potentiators, food-grade acids, minerals, micronutrients, plant extracts, phytochemicals (“phytonutrients”), preservatives, salts including buffering salts, stabilizers, thickening agents, medicaments, vitamins, or a combination comprising at least one of the foregoing additives. Those of ordinary skill in the art will appreciate that certain additives may meet the definition or function according to more than one of the above-listed additive categories.

### Concentrate Compositions

Concentrate compositions may be in dry form (e.g., powder or tablet) or in liquid form (e.g., syrup, suspension, or emulsion). Concentrate compositions typically include the flavoring agent in a volume of liquid medium that is less than the volume of liquid medium found in the finished beverage. Other optional components in the concentrate include additional sweetening agents, coloring agents, and other additives such as food-grade acids, preservatives, and the like. The bulk of the liquid component of a finished beverage composition is not present in the concentrate to allow for reduced weight, volume, storage and shipping costs while at the same time allowing for increased shelf life of the concentrate versus beverage composition.

In one embodiment, the concentrate composition is formulated to provide final beverage compositions upon dilution with about a 2-fold to about a 5-fold by volume, specifically about 3-fold to about a 4-fold by volume of a liquid. The liquid may be water, juice, dairy component, a non-dairy milk, ethanol, a combination comprising at least one of the foregoing, and the like. The liquid may be in noncarbonated or carbonated form.

In order that the present invention may be more readily understood, it will be described further with reference to the specific examples hereinafter.

### EXAMPLE 1

A solution containing LHG at ˜3% SEV (sucrose equivalent value) (275 ppm mogroside) with a pH of 3.2 was prepared. This was used as the reference sample throughout the evaluation of example 1.

Erythritol was added to this solution at 1% w/v, 2% w/v and 3% w/v (maximum permitted level in beverages). Samples were tasted against the LHG reference sample and it was found that there was a decrease in the off-flavors at all levels, but that 3% w/v was the most effective. The addition of erythritol also rounded out the sweetness profile, enhancing the sweetness and reducing the lingering sweet aftertaste.

Further work was carried out on these samples. A solution of LHG at ˜3% SEV was prepared with the addition of sucrose at 1.95% w/v to theoretically match the sweetness level given by addition of 3% w/v erythritol. This evaluation showed that the erythritol added enhanced sweetness and also helped to mask the off-flavours whereas adding sucrose merely enhanced the sweetness of the LHG solution

Magnesium gluconate was evaluated at the following levels in the reference solution: 100 ppm, 150 ppm and 200 ppm. On comparison to the reference sample it was judged that addition of 200 ppm magnesium gluconate alone softened the flavor profile of LHG reducing the harsh notes, although to a lesser extent than erythritol.

Tagatose was added was to the reference LHG solution at 0.5% w/v and 1% w/v (maximum level). On comparison to the reference sample solutions, it was found that inclusion of tagatose at 1% w/v masked the off-notes associated with the LHG and enhanced the sweetness profile by reducing the lingering sweet aftertaste.

Combination of erythritol (3% w/v) and magnesium gluconate (200 ppm) in the LHG reference solution was judged to be more effective than using the single ingredients.

A blend containing erythritol (3% w/v), tagatose (1% w/v) and magnesium gluconate (200 ppm) in the reference LHG solution was evaluated and judged to improve the overall profile of the reference solution more than either a single ingredient, or a two-component blend, giving a product with a more balanced sweetness profile and less harsh flavor. It was found that addition of erythritol, tagatose and magnesium resulted in a decrease in the off-flavours and caused a reduction in the lingering sweetness typical of LHG.

### EXAMPLE 2

The base formulation of Table 2 was used in this example.

TABLE 2
Base formulation.

| Ingredient | % w/v |
|---|---|
| Lo Han Guo* Pure Lo 2006 crop | 0.0340 |
| Citric acid monohydrate | 0.200 |
| Trisodium citrate | 0.040 |
| Water | To volume |
| Erythritol | 3.000 |

The citric acid monohydrate and trisodium citrate of the base formulation are included solely to achieve a pH and acidity which would be similar to a soft drink system.

Compositions of the invention were prepared by adding various salts of monocarboxylic acids to the base formulation as shown in table 2. The compositions were then tasted. The comments on the taste profile of the compositions are provided in table 3 below.

TABLE 3
Base formulation of table 2 with addition
of various salts of monocarboxylic acids.

| Addition/Variation | Level of | |
|---|---|---|
| to Base | organic | |
| Formulation | salt ppm | Comments on taste |
| Control 1 (Base | — | Typical LHG flavor. |
| formulation of | | Delayed onset of sweetness and |
| table 2 without | | lingering sweetness. |
| Erythritol) | | |
| Control 2 - Base | — | Slight lo han guo off-flavour and |
| formulation of | | aroma. |
| table 2 | | Sweetness slightly delayed. |
| (with no salt of a | | Slight icing sugar type sweetness |
| monocarboxylic | | compared to Control 1 without |
| acid) this is | | Cleaner flavor profile, with reduced |
| covered by the | | LHG flavor. |
| claim | | More upfront sweetness which was |
| | | less lingering. |
| Magnesium | 188 | Cleaner profile than Control 1 or 2 |
| gluconate | | with less LHG flavor. |
| | | Slightly less lingering sweetness. |
| | | Reduced the sweetness slightly. |
| Sodium gluconate | 188 | Similar profile to magnesium |
| | | gluconate. |
| | | Quite rounded, slightly more acidic |
| | | than above. |
| | | Slightly bitter and drying, reduced |
| | | mouthfeel and LHG flavor. |
| | | Reduced the lingering sweetness. |
| | | Reduced the LHG flavor. |
| Calcium gluconate | 188 | Soft mouthfeel, slightly astringent. |
| | | Quite clean. |
| | | LHG flavor reduced slightly. |
| Potassium | 188 | Quite clean. |
| gluconate: | | |
| Gluconal KG | | |
| Zinc gluconate | 188 | Slightly drying, more LHG flavor |
| | | present. |
| | | Least effective salt. |
| Magnesium | 188 | Slightly bitter and drying. |
| Lactate | | Slightly reduced mouthfeel, LHG |
| | | flavor and lingering sweetness |
| Sodium Lactate | 188 ppm | Cleaner flavor profile with reduced |
| | | LHG. |
| | | Slightly reduced sweetness, which |
| | | was less lingering. |
| Calcium Lactate | 188 | LHG flavor reduced slightly. |
| | | Reduced sweetness, which was still |
| | | lingering. |

It can be seen from Table 3 that the sodium gluconate was the closest to the magnesium gluconate in terms of flavor masking effects and improved taste profile.

Erythritol is effective at masking the LHG flavor. A combination of erythritol with magnesium gluconate had the greatest impact on improving the LHG flavor profile, although the combination of erythritol with other salts of monocarboxylic acids also worked well. The lingering sweetness associated with LHG was slightly suppressed in all of the combinations.

### EXAMPLE 3

The base formulation of Table 2 was used, but with maltitol used in place of erythritol.

TABLE 4
Base formulation with addition of different organic salts.

| Addition/Variation | Level of | |
|---|---|---|
| to Base | organic | |
| Formulation | salt % w/v | Comments on taste |
| Control 1 (base | — | Typical LHG flavor. |
| formulation of | | Delayed, lingering sweetness. |
| table 2 without | | |
| Maltitol) | | |
| Control 2 - base | — | Typical LHG flavor. |
| formulation of | | Sweetness seemed slightly more |
| table 2 (with no | | rounded and upfront. |
| salt of a | | Covered by claim |
| monocarboxylic | | |
| acid) | | |
| Maltitol & | 0.0206 | Cleaner profile with a reduction |
| Magnesium | (188 ppm) | in the LHG flavor. |
| Gluconate | | Very slightly bitter, reduced the |
| | | lingering sweetness. |
| Maltitol & | 0.0228 | Slightly bitter and astringent. |
| Magnesium | (188 pm) | Reduced lingering sweetness. |
| Lactate | | |
| Maltitol & | 0.0210 | Cleaner profile with a slight |
| Sodium Gluconate | (188 ppm) | reduction in LHG flavor. |
| | | Reduced lingering sweetness. |
| Maltitol & | 0.0394 | Typical LHG flavor. |
| Sodium Lactate | (188 ppm) | Reduced lingering sweetness. |
| Maltitol & | 0.0212 | Slight reduction in LHG flavor. |
| Calcium Gluconate | (188 ppm) | Sweetness slightly suppressed. |
| Maltitol & | 0.0324 | Typical LHG flavor. |
| Calcium Lactate | (188 ppm) | Reduced lingering sweetness. |

It can be seen from Table 4 that the combinations of maltitol with magnesium gluconate, and maltitol with sodium gluconate exhibited a superior impact on improving the LHG flavor profile, although all formulations reduced the lingering sweetness associated with LHG.

### EXAMPLE 4

The base formulation of Table 2 was used, but with sorbitol (Neosorb P60) used in place of erythritol.

Formulations were made up by adding organic salts given in table 5 below to the base formulation of Table 2. These were then tasted to determine the LHG taste profile.

TABLE 5
Base formulation and addition of different organic salts.

| Addition/Variation | Level of | |
|---|---|---|
| to Base | organic salt | |
| Formulation | % w/v | Comments on taste |
| Control 1 - base | — | Typical LHG flavor. |
| formulation | | Delayed, lingering sweetness |
| without sorbitol | | |
| Control 2 - base | — | Cleaner profile with a slight |
| formulation (with | | reduction in LHG flavor. |
| no salt of a | | Less lingering sweetness. |
| monocarboxylic | | |
| acid) | | |
| Sorbitol & | 0.0206 | Cleaner profile with a slight |
| Magnesium | (188 ppm) | reduction in LHG flavor. |
| Gluconate | | Less lingering sweetness, which |
| | | was more rounded. |
| Sorbitol & | 0.0228 | Cleaner profile with a slight |
| Magnesium | (188 ppm) | reduction in LHG flavor. |
| Lactate | | Less lingering sweetness, which |
| | | was more rounded. |
| Sorbitol & | 0.0210 | Slight reduction in LHG flavor. |
| Sodium Gluconate | (188 ppm) | Less lingering sweetness, which |
| | | was more rounded and upfront. |
| Sorbitol & | 0.0394 | Slight reduction in LHG flavor. |
| Sodium Lactate | (188 ppm) | More rounded sweetness. |
| Sorbitol & | 0.0212 | Slight reduction in LHG flavor. |
| Calcium | (188 ppm) | More rounded sweetness, with |
| Gluconate | | cleaner aftertaste reducing the |
| | | lingering sweetness, slightly bitter |
| | | in the aftertaste. |
| Sorbitol & | 0.0324 | Slight reduction in LHG flavor. |
| Calcium Lactate | (188 ppm) | More rounded sweetness, with |
| | | cleaner aftertaste reducing the |
| | | lingering sweetness, slightly |
| | | drying and astringent. |

It can be seen from Table 5 that there was a reduction in the LHG flavor for all formulations of sorbitol and organic salts. The sweetness was also slightly more rounded when the salts were present, compared to Controls 1 and 2.

### EXAMPLE 5

The base formulation of Table 2 was used, but with the combination of the sugar alcohol maltitol at 3.0 w/v % and the sugar tagatose at 1.0 w/v % used in place of erythritol.

Different salts of monocarboxylic acids were added to the base formulation, as given in Table 6 below, and tasted to determine the LHG taste profile.

TABLE 6
Base formulation and addition of different organic salts

| Addition/Variation to | Level of organic | |
|---|---|---|
| Base Formulation | salt % w/v | Comments |
| Control 1 - base | — | Typical LHG flavor. |
| formulation without | | Delayed, lingering sweetness. |
| maltitol and tagatose | | |
| Control 2 - base | — | Cleaner profile with a reduction in LHG flavor. |
| formulation without | | Sweeter than control 1 |
| tagatose | | |
| Control 3 - base | 0.0206 | Cleaner profile with a reduction in LHG flavor. |
| formulation (including | (188 ppm) | |
| maltitol & tagatose) | | |
| maltitol, tagatose & | 0.0206 | Slight LHG flavor characteristics still present, |
| magnesium gluconate | (188 ppm) | but less than Controls 1-3. |
| maltitol, tagatose & | 0.0228 | LHG flavor characteristics still present, but less |
| magnesium lactate | (188 ppm) | than Controls 1-3. |
| maltitol, tagatose & | 0.0210 | LHG flavor characteristics still present, but less |
| sodium gluconate | (188 ppm) | than Controls 1-3. |
| maltitol, tagatose & | 0.0394 | LHG flavor characteristics still present, but less |
| sodium lactate | (188 ppm) | than Controls 1-3. |
| maltitol, tagatose & | 0.0212 | Cleaner profile than Controls 1-3. |
| calcium gluconate | (188 ppm) | |
| maltitol, tagatose & | 0.0324 | LHG flavor characteristics still present, but less |
| calcium lactate: Puracal | (188 ppm) | than Controls 1-3. |

### EXAMPLE 6

Example 5 was repeated using the base formulation of Table 2 (containing erythritol), but additionally with tagatose at 1.0 w/v %.

TABLE 7
Base formulation and addition of different organic salts

| | Supplier | | |
|---|---|---|---|
| | of | Level of | |
| Addition/Variation | organic | organic | |
| to Base Formulation | salts | salt % w/v | Comments |
| Control 1 - base | | — | typical LHG flavor. |
| formulation with no | | | Delayed, lingering |
| erythritol or tagatose | | | sweetness. |
| Control 2 - base | — | — | Cleaner profile with a |
| formulation with no | | | reduction in LHG flavor. |
| tagatose | | | Less lingering sweetness. |
| Control 3 - base | Aldrich | 0.0206 | Reduction in LHG flavor |
| formulation alone | | (188 ppm) | compared to Controls. |
| Erythritol, Tagatose | Purac | 0.0206 | Cleaner profile, with |
| & Magnesium | | (188 ppm) | reduction in LHG flavor |
| Gluconate | | | compared to Controls. |
| Erythritol, Tagatose | Fiske | 0.0228 | Slightly cleaner, reduction |
| & Magnesium | | (188 ppm) | in LHG flavor compared to |
| Lactate | | | Controls. |
| Erythritol, Tagatose | Purac | 0.0210 | Reduction in LHG flavor |
| & Sodium Gluconate | | (188 pm) | compared to Controls. |
| Erythritol, Tagatose | Sigma | 0.0394 | Reduction in LHG flavor |
| & Sodium Lactate | | (188 ppm) | compared to Controls. |
| Erythritol, Tagatose | Purac | 0.0212 | Reduction in LHG flavor |
| & Calcium | | (188 ppm) | compared to Controls. |
| Gluconate | | | |
| Erythritol, Tagatose | Purac | 0.0324 | Reduction in LHG flavor |
| & Calcium Lactate | | (188 ppm) | compared to Controls. |

It can be seen from Table 7 that erythritol seems to have the greater impact on the flavor. The tagatose increased the sweetness intensity. Addition of magnesium gluconate and lactate to this combination improved the profile compared to the control samples.

### EXAMPLE 7

The example given in Example 6 was repeated but the base formulation of Table 2 was used with Sorbitol (Neosorb P60) at 3.0 w/v % and tagatose at 1.0 w/v % being used in place of erythritol, as shown in Table 8 below.

TABLE 8
Base formulations with various organic salts

| | Level of | |
|---|---|---|
| Addition/Variation to | organic salt | |
| Base Formulation | % w/v | Comments on taste |
| Control 1 - base | — | Typical LHG flavor. |
| formulation (without | | Delayed, lingering |
| sorbitol or tagatose) | | sweetness. |
| Control 2 - base | — | Slightly cleaner profile |
| formulation with | | with a reduction in LHG |
| Sorbitol only | | flavor. |
| | | Lingering sweetness. |
| Control 3 - base | 0.0206 | Slightly cleaner profile |
| formulation | (188 ppm) | with a reduction in LHG |
| | | flavor. |
| | | Lingering sweetness. |
| Sorbitol, Tagatose & | 0.0206 | Slightly cleaner profile |
| Magnesium Gluconate | (188 ppm) | with a reduction in LHG |
| | | flavor. |
| | | Lingering sweetness. |
| Sorbitol, Tagatose & | 0.0228 | Slightly cleaner profile |
| Magnesium Lactate | (188 ppm) | with a reduction in LHG |
| | | flavor. |
| Sorbitol, Tagatose & | 0.0210 | Slightly cleaner profile |
| Sodium Gluconate | (188 ppm) | with a reduction in LHG |
| | | flavor. |
| Sorbitol, Tagatose & | 0.0394 | Slightly cleaner profile |
| Sodium Lactate | (188 ppm) | with a reduction in LHG |
| | | flavor. |
| Sorbitol, Tagatose & | 0.0212 | Slightly cleaner profile |
| Calcium Gluconate | (188 ppm) | with a reduction in LHG |
| | | flavor. |
| Sorbitol, Tagatose & | 0.0324 | Slightly cleaner profile |
| Calcium Lactate: | (188 ppm) | with a reduction in LHG |
| Puracal | | flavor. |

It can be seen from Table 8 that all the formulations did have a slightly cleaner profile with a reduction in LHG. All samples were sweeter than Control 1

### EXAMPLE 8

Example 6 was repeated, with the base formulation of Table 2 but additionally with fructose at 1.0 w/v %.

The results are given in Table 9 below.

TABLE 9
Base formulations with various organic salts

| Addition/Variation | | |
|---|---|---|
| to Base | Level of organic | |
| Formulation | salt % w/v | Comments |
| Control 1 - base | — | Typical LHG flavor. |
| formulation used | | Delayed, lingering |
| with no erythritol | | sweetness. |
| or fructose | | |
| Control 2 - base | — | Cleaner profile with a |
| formulation with | | reduction in LHG flavor. |
| Erythritol | | Less lingering sweetness. |
| Control 3 - base | 0.0206 | Slightly cleaner profile with |
| formulation | (188 ppm) | a reduction in LHG flavor. |
| (Erythritol & | | Enhanced sweetness. |
| Fructose) | | |
| Erythritol, Fructose | 0.0206 | Slightly cleaner profile with |
| and Magnesium | (188 ppm) | a reduction in LHG flavor, |
| Gluconate | | enhanced sickly sweetness. |
| Erythritol, Fructose | 0.0228 | Slightly cleaner profile with |
| & Magnesium | (188 ppm) | a reduction in LHG flavor. |
| Lactate | | Enhanced sweetness. |
| Erythritol, Fructose | 0.0210 | Slightly cleaner profile with |
| & Sodium | (188 ppm) | a reduction in LHG flavor. |
| Gluconate | | Enhanced sweetness. |
| Erythritol, Fructose | 0.0394 | Slightly cleaner profile with |
| & Sodium Lactate | (188 ppm) | a reduction in LHG flavor. |
| | | Enhanced sweetness. |
| Erythritol, Fructose | 0.0212 | Slightly cleaner profile with |
| & Calcium | (188 ppm) | a reduction in LHG flavor. |
| Gluconate | | Enhanced sweetness. |
| Erythritol, Fructose | 0.0324 | Slightly cleaner profile with |
| & Calcium Lactate | (188 ppm) | a reduction in LHG flavor. |
| | | Enhanced sweetness. |

It can be seen from Table 9 that all samples were sweeter than the control. These formulations did have a cleaner profile with a reduction in LHG flavor.

A blend of erythritol, tagatose and magnesium gluconate or magnesium lactate provided the cleanest taste, with enhanced sweetness and improved sweetness profile.

It is to be understood that the invention is not to be limited to the details of the above embodiments, which are described by way of example only. Many variations are possible.

1. A sweetener composition comprising;
an extract of a fruit from the Cucurbitaceae family;
at least one sugar alcohol; and
at least one salt of a monocarboxylic acid and/or at least one salt of a dicarboxylic acid.

2. The sweetener composition of claim 1, wherein the extract of fruit from the Cucurbitaceae family comprises Lo Han Guo.

3. The sweetener composition claim 1, wherein the sugar alcohol comprises any of erythritol, isomalt, lactitol, maltitol, mannitol, sorbitol, xylitol or any combination thereof.

4. The sweetener composition of claim 1, wherein the sugar alcohol is present in the range from 0.1% to 10% by weight of the sweetener composition.

5. The sweetener composition of claim 1, wherein the salt is at least one of an alkali metal salt or an alkaline earth metal salt of at least one monocarboxylic acid and/or at least one dicarboxylic acid.

6. The sweetener composition of claim 1, wherein the salt is a salt of a monocarboxylic acid having a linear, optionally branched, backbone with a carbon chain length in the range from C1 to C10.

7. The sweetener composition of claim 1, wherein the at least one salt of monocarboxylic acid and/or at least one salt of -dicarboxylic acid is present in the range from 0.001% to 1.0% by weight of the sweetener composition.

8. The sweetener composition of claim 1, wherein the sweetener composition further comprises at least one saccharide

9. The sweetener composition of claim 8, wherein the saccharide is present in the range from 0.01% to 10% by weight of the sweetener composition.

10. A beverage or foodstuff comprising the sweetener composition of claim 1.

11. A method of making a sweetener composition comprising the steps of
providing an extract of a fruit from the Cucurbitaceae family; and
mixing said extract with at least one sugar alcohol and at least one salt of a monocarboxylic acid and/or at least one salt of a dicarboxylic acid.

12. A method of reducing a bitter taste of an extract of a fruit from the Cucurbitaceae family, the method comprising combining the extract of a fruit from the Cucurbitaceae family with
at least one sugar alcohol, and
at least one salt of a monocarboxylic acid and/or at least one salt of a dicarboxylic acid.

13. A sweetener composition, said composition comprising;
an extract of a fruit from the Cucurbitaceae family;
at least one sugar alcohol; and
at least one of an alkali metal cation and/or an alkaline earth metal cation.

14. A method of making a sweetener composition comprising the steps of
providing an extract of a fruit from the Cucurbitaceae family; and
mixing said extract with at least one of an alkali metal cation and/or an alkaline earth metal cation.

15. A method of reducing a bitter taste of an extract of a fruit from the Cucurbitaceae family, the method comprising combining an extract of a fruit from the Cucurbitaceae family with
at least one sugar alcohol, and
at least one of an alkali metal cation and/or an alkaline earth metal cation.
